(19) United States
(12) Patent Application Publication
(10) Pub. No.: US 2023/0244815 A1
(43) Pub. Date: Aug. 3, 2023

(54) ANONYMIZING PERSONALLY IDENTIFIABLE INFORMATION IN SENSOR DATA

(71) Applicant: Ford Global Technologies, LLC, Dearborn, MI (US)

(72) Inventors: David Michael Herman, West Bloomfield, MI (US); Alexander George Shanku, Grosse Pointe Park, MI (US)

(73) Assignee: Ford Global Technologies, LLC, Dearborn, MI (US)

(21) Appl. No.: 17/590,284

(22) Filed: Feb. 1, 2022

(51) Int. Cl. G06F 21/62; G06T 5/00; G06T 7/70

(52) U.S. Cl. CPC G06F 21/6254; G06T 5/002; G06T 7/70; G06T 2207/30201

(57) ABSTRACT

A computer includes a processor and a memory, and the memory stores instructions executable by the processor to receive sensor data in a time series from a sensor, identify an object in the sensor data, generate anonymized data for the object at a first time in the time series based on the sensor data of the object at the first time, and apply the same anonymized data to an instance of the object in the sensor data at a second time in the time series. The object includes personally identifiable information.

### BACKGROUND

Vehicles can include a variety of sensors. Some sensors detect internal states of the vehicle, for example, wheel speed, wheel orientation, and engine and transmission values. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back.

### BRIEF DESCRIPTION OF THE DRAWINGS

FIG. 1 is a block diagram of an example vehicle.

FIG. 2A is a diagram of an example first image frame from a sensor of the vehicle.

FIG. 2B is a diagram of an example second image frame from the sensor.

FIG. 3A is a diagram of the first image frame after an example anonymization.

FIG. 3B is a diagram of the second image frame after a first example anonymization.

FIG. 3C is a diagram of the second image frame after a second example anonymization.

FIG. 3D is a diagram of the second image frame after a third example anonymization.

FIG. 3E is a diagram of a point cloud from a sensor of the vehicle.

FIG. 4 is a process flow diagram for anonymizing data from the sensor.

### DETAILED DESCRIPTION

The system and techniques described herein can provide anonymization of objects in sensor data over a time series in a manner that can prevent re-identification from the time-series sensor data. Examples of personally identifiable information (PII) in sensor data include images or point clouds of faces, images of signs or text such as license plates, etc. It is possible to de-anonymize PII in sensor data by using the sensor data over time or over multiple views. For example, if someone has camera images of multiple views of a person's face with the face blurred in each image, techniques exist to reconstruct a high-resolution image of the face or a model of depth features of the face using the multiple blurred views of the face, e.g., with machine learning. The different blurred views contain different leftover information of the face, so the multiple blurred views may collectively provide sufficient information to reconstruct the face.

The techniques herein include receiving sensor data in a time series from a sensor, identifying an object including PII in the sensor data, generating anonymization data for a first instance of the object at a first time in the time series based on the sensor data of the first instance, and applying the same anonymization data to a second instance of the object in the sensor data at a second time in the time series, e.g., to each instance of the object in the sensor data. By applying the same anonymization data to each instance rather than anonymizing each instance independently, even the sensor data over the time series may not provide sufficient information to de-anonymize the PII object. The system and techniques herein may thus provide robust protection of PII. Moreover, by applying the same anonymization data to each instance rather than completely redacting the PII (e.g., by applying black boxes over the instances of the PII object), the sensor data may be more suitable for various types of analysis post-anonymization, e.g., to assess performance of a vehicle and/or subsystems thereof, e.g., advanced driver assistance systems (ADAS) of a vehicle.

A computer includes a processor and a memory, and the memory stores instructions executable by the processor to receive sensor data in a time series from a sensor, identify an object in the sensor data, generate anonymization data for a first instance of the object at a first time in the time series based on the sensor data of the first instance, and apply the same anonymization data to a second instance of the object in the sensor data at a second time in the time series. The object includes personally identifiable information.

The sensor data in the time series may include a sequence of image frames, generating the anonymization data for the object may occur for a first image frame of the image frames, and applying the same anonymization data to the second instance of the object may occur for a second image frame of the image frames. The object may include text, and applying the same anonymization data to the second instance of the object may include blurring the text.

The object may include a face of a person, and applying the same anonymization data to the second instance of the object may include blurring the face. The anonymization data may be a randomized facial feature vector. The instructions may further include instructions to determine a pose of the face in the second image frame, and applying the same anonymization data to the second instance of the object may be based on the pose. Applying the same anonymization data to the second instance of the object may include to generate a subframe image of an anonymized face from the randomized facial feature vector in the pose of the face in the second image frame. Applying the same anonymization data to the second instance of the object may include to apply the subframe image of the anonymized face to the second image frame, and blur the subframe image.

The anonymization data may be a subframe image of the first instance of the object from the first image frame. Applying the same anonymization data to the second instance of the object may include applying the subframe image to the second image frame and then blurring the subframe image in the second image frame.

The instructions may further include instructions to blur the subframe image in the first image frame.

Generating the anonymization data may include blurring a subframe image of the first instance of the object in the first image frame, and applying the same anonymization data to the second instance of the object may include applying the blurred subframe image to the second instance of the object in the second image frame.

Applying the same anonymization data to the second instance of the object may include blurring a location of the object in the second image frame, and blurring the location of the object in the second image frame may be based on contents of the second image frame. The instructions may further include instructions to blur the first instance of the object in the first image frame, and blurring the first instance in the first image frame may be based on contents of the first image frame.

The object may include a face of a person.

The instructions may further include instructions to apply the same anonymization data to each instance of the object in the sensor data. Applying the same anonymization data to each instance of the object includes applying the same anonymization data to instances of the object before the object is occluded from the sensor and to instances of the object after the object is occluded from the sensor.

The sensor may be a first sensor, the sensor data may be first sensor data, and the instructions may further include instructions to receive second sensor data in the time series from a second sensor, and apply the same anonymization data to a third instance of the object in the second sensor data. The first sensor and the second sensor may be mounted to a same vehicle during the time series.

A method includes receiving sensor data in a time series from a sensor, identifying an object in the sensor data, generating anonymization data for a first instance of the object at a first time in the time series based on the sensor data of the first instance, and applying the same anonymization data to a second instance of the object in the sensor data at a second time in the time series.

With reference to the Figures, wherein like numerals indicate like parts throughout the several views, a vehicle computer 102 of a vehicle 100 or a remote computer 104 that is remote from the vehicle 100 includes a processor and a memory, and the memory stores instructions executable by the processor to receive sensor data in a time series from a sensor 106, identify an object 108 in the sensor data, generate anonymization data for a first instance 110 of the object 108 at a first time in the time series based on the sensor data of the first instance 110a, and apply the same anonymization data to a second instance 110b of the object 108 in the sensor data at a second time in the time series. The object 108 includes personally identifiable information.

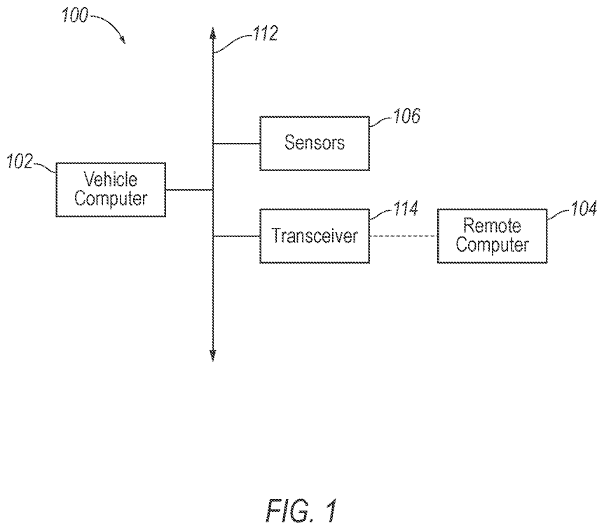

With reference to FIG. 1, the vehicle 100 may be any passenger or commercial automobile such as a car, a truck, a sport utility vehicle, a crossover, a van, a minivan, a taxi, a bus, a jeepney, etc.

The vehicle computer 102 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The vehicle computer 102 can thus include a processor, a memory, etc. The memory of the vehicle computer 102 can include media for storing instructions executable by the processor as well as for electronically storing data and/or databases, and/or the vehicle computer 102 can include structures such as the foregoing by which programming is provided. The vehicle computer 102 can be multiple computers coupled together on board the vehicle 100.

The vehicle computer 102 may transmit and receive data through a communications network 112 such as a controller area network (CAN) bus, Ethernet, WiFi, Local Interconnect Network (LIN), onboard diagnostics connector (OBD-II), and/or by any other wired or wireless communications network. The vehicle computer 102 may be communicatively coupled to the sensors 106, a transceiver 114, and other components via the communications network 112.

The sensors 106 may detect the external world, e.g., the objects 108 and/or characteristics of surroundings of the vehicle 100, such as other vehicles, road lane markings, traffic lights and/or signs, pedestrians, etc. For example, the sensors 106 may include radar sensors, scanning laser range finders, light detection and ranging (LIDAR) devices, and image processing sensors such as cameras. For example, the sensors 106 may include cameras and may detect visible light, infrared radiation, ultraviolet light, or some range of wavelengths including visible, infrared, and/or ultraviolet light, which may include polarization data. For example, the camera can be a charge-coupled device (CCD), complementary metal oxide semiconductor (CMOS), or any other suitable type. For another example, the sensors 106 may include a time-of-flight (TOF) camera, which include a modulated light source for illuminating the environment and detect both reflected light from the modulated light source and ambient light to sense reflectivity amplitudes and distances to the scene. For another example, the sensors 106 may include LIDAR devices, e.g., scanning LIDAR devices. A LIDAR device detects distances to objects 108 by emitting laser pulses at a particular wavelength and measuring the time of flight for the pulse to travel to the object 108 and back. For another example, the sensors 106 may include radars. A radar transmits radio waves and receives reflections of those radio waves to detect physical objects 108 in the environment. The radar can use direct propagation, i.e., measuring time delays between transmission and reception of radio waves, and/or indirect propagation, i.e., Frequency Modulated Continuous Wave (FMCW) method, i.e., measuring changes in frequency between transmitted and received radio waves.

The transceiver 114 may be adapted to transmit signals wirelessly through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The transceiver 114 may be adapted to communicate with the remote computer 104, that is, a server distinct and spaced from the vehicle 100. The remote computer 104 may be disconnected from the vehicle 100 and located outside the vehicle 100. The transceiver 114 may be one device or may include a separate transmitter and receiver.

The remote computer 104 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The remote computer 104 can thus include a processor, a memory, etc. The memory of the remote computer 104 can include media for storing instructions executable by the processor as well as for electronically storing data and/or databases, and/or the remote computer 104 can include structures such as the foregoing by which programming is provided. The remote computer 104 can be multiple computers coupled together.

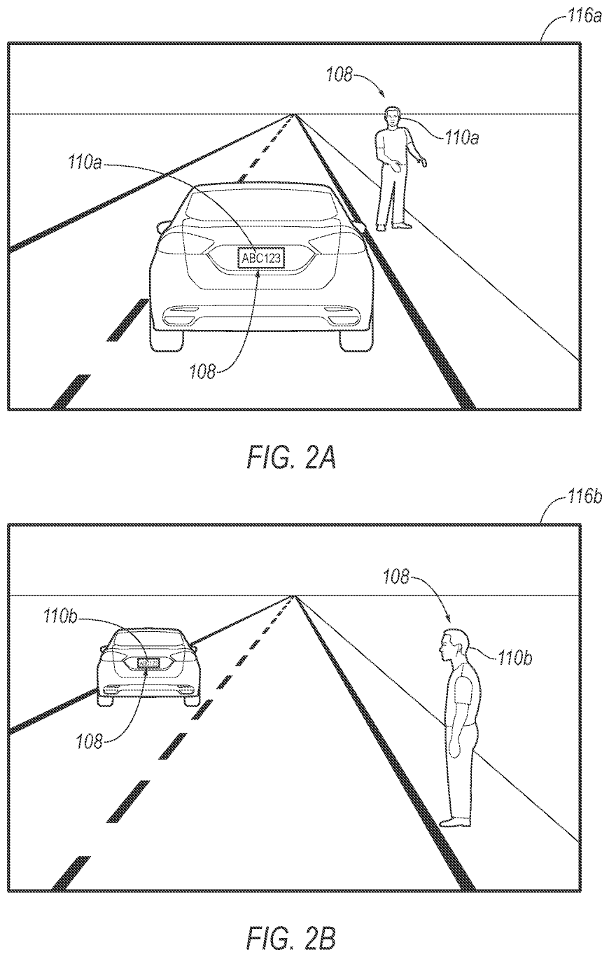

With reference to FIGS. 2A-B, the vehicle computer 102 or remote computer 104 can be programmed to receive sensor data in a time series from the sensors 106. As will be generally understood, and for the purposes of this disclosure, data in a time series are data at discrete successive points of time. For example, when the sensors 106 include a camera, the sensor data in the time series can include a sequence of image frames 116. FIG. 2A shows an example first image frame 116a at a first time, and FIG. 2B shows an example second image frame 116b at a second time later in the sequence of image frames 116. For another example, when the sensors 106 include a LIDAR or radar, the sensor data in the time series can include a series of point clouds at successive points of time. For another example, the sensor data in the time series, e.g., after processing, can include a series of depth maps at successive points of time.

When the sensor data is from a camera, each image frame 116 can be a two-dimensional matrix of pixels. Each pixel can have a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Position in an image frame 116, i.e., position in the field of view of the sensor 106 at the time that the image frame 116 was recorded, can be specified in pixel dimensions or coordinates, e.g., an ordered pair of pixel distances, such as a number of pixels from a top edge and a number of pixels from a left edge of the field of view.

The vehicle computer 102 or remote computer 104 can be programmed to receive the sensor data in the time series from multiple sensors 106. The sensors 106 can be mounted to the vehicle 100 during the time series, i.e., to the same vehicle 100 even if the remote computer 104 is receiving the sensor data.

The objects 108 include personally identifiable information (PII), i.e., PII can be obtained or determined from respective objects 108 when they are unobscured. For the purposes of this disclosure, personally identifiable information is defined as a representation of information that permits the identity of an individual to whom the information applies to be reasonably inferred. For example, an object 108 can include a face of a person, e.g., of a pedestrian in the vicinity of the vehicle 100 as the vehicle 100 travels as shown in FIGS. 2A-B. For another example, an object 108 can include text, e.g., on a license plate of another vehicle 100 as shown in FIG. 2A-B. Other examples include gait, speech usable for voice recognition, and so on.

The vehicle computer 102 or remote computer 104 can be programmed to identify instances 110 of the objects 108 in the sensor data using conventional image-recognition techniques, e.g., a convolutional neural network programmed to accept images as input and output an identified object 108. A convolutional neural network includes a series of layers, with each layer using the previous layer as input. Each layer contains a plurality of neurons that receive as input data generated by a subset of the neurons of the previous layers and generate output that is sent to neurons in the next layer. Types of layers include convolutional layers, which compute a dot product of a weight and a small region of input data; pool layers, which perform a downsampling operation along spatial dimensions; and fully connected layers, which generate based on the output of all neurons of the previous layer. The final layer of the convolutional neural network generates a score for each potential classification of the object 108, and the final output is the classification with the highest score, e.g., “face” or “license plate.” For another example, if the sensor data is a point cloud, the vehicle computer 102 or remote computer 104 can use semantic segmentation to identify points in the point cloud that form the instance 110 of the object.

The vehicle computer 102 or remote computer 104 can be programmed to identify multiple instances 110 of the same object 108 as being of the same object 108 across different times and across sensor data from different sensors 106. For example, the vehicle computer 102 or remote computer 104 can identify instances 110 of the object 108 both before and after the object 108 is occluded from the sensor 106 (e.g., by being blocked from the field of view of the sensor 106 by something in the foreground) as being instances 110 of the same object 108. For example, the vehicle computer 102 or remote computer 104 can use object-identification and object-tracking techniques, as are known. For example, the vehicle computer 102 or remote computer 104 can identify instances 110 of the object 108 in the first image frame 116a and the second image frame 116b as being instances 110 of the same object 108, whether the first and second image frames 116a-b are received from the same sensor 106 or different sensors 106.

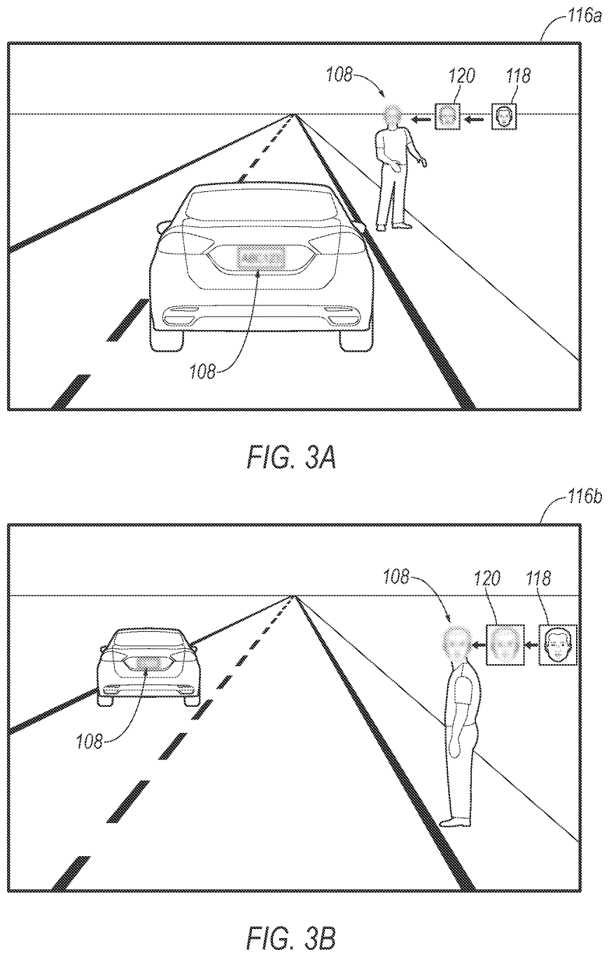

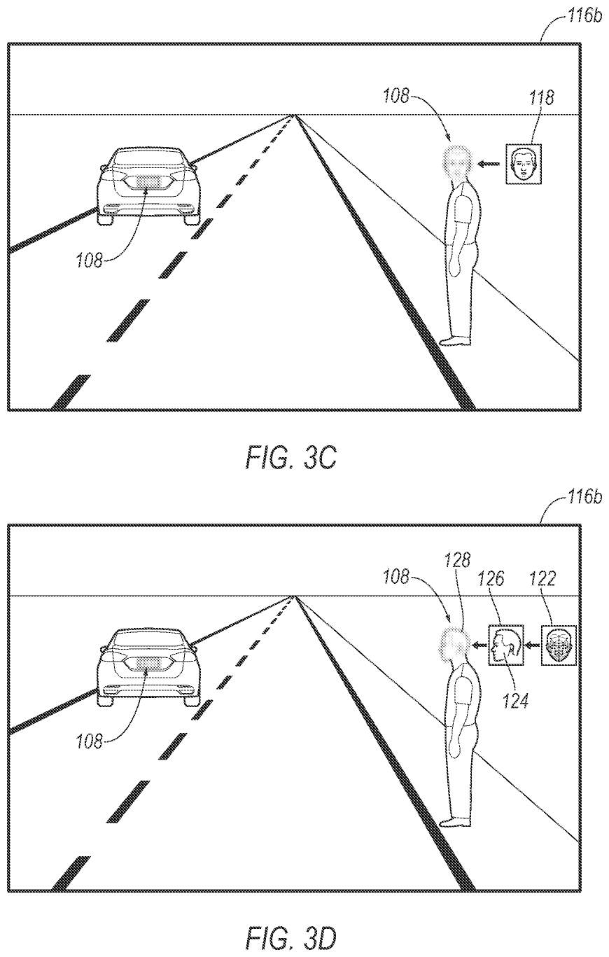

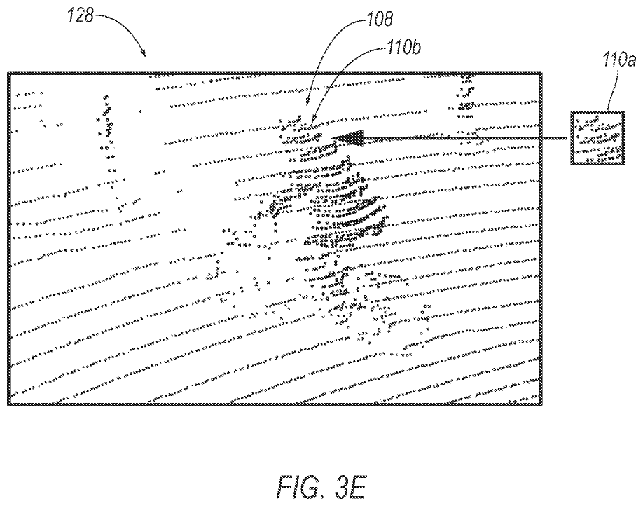

With reference to FIG. 3A, the vehicle computer 102 or remote computer 104 can be programmed to anonymize the first instance 110a of the object 108 at the first time in the sensor data. For example, the vehicle computer 102 or remote computer 104 can be programmed to blur the first instance 110a of the object 108 in the first image frame 116a, e.g., by blurring a subframe image 118 of the first image frame 116a that contains the first instance 110a of the object 108, i.e., by blurring the location of the object 108 in the first image frame 116a. For the purposes of this disclosure, a “subframe image” is defined as a region of an image frame that is smaller than that image frame. The result is a new, blurred subframe image 120 applied to the location of the unblurred subframe image 118 in the first image frame 116a. Blurring the first instance 110a can be based on contents of the first image frame 116a. For example, the vehicle computer 102 or remote computer 104 can use any suitable blurring techniques that transform the contents of the first image frame 116a, e.g., Gaussian blurring. For another example, if the sensor data is a point cloud, the vehicle computer 102 or remote computer 104 can apply a Gaussian position adjustment to points forming the first instance 110a of the object 108, i.e., moving the positions of the points in three-dimensional space by an adjustment determined with a Gaussian distribution.

The vehicle computer 102 or remote computer 104 can be programmed to generate anonymization data for the first instance 110a of the object 108 at the first time in the time series, e.g., for the first image frame 116a. The anonymization data can be the blurred subframe image 120 from anonymizing the first instance 110a; the subframe image 118 before blurring, which is then blurred after application to other instances 110 of the object 108 in the sensor data; a randomized facial feature vector 122, which is used to generate a synthetic subframe image 126 of an anonymized face 124 that is then blurred; or the adjusted positions of the points of a point cloud forming the first instance 110a, each of which will be described in turn below.

With reference to FIGS. 3B-E, the vehicle computer 102 or remote computer 104 can be programmed to apply the same anonymization data to a second instance 110b of the object 108 at a second time in the sensor data, e.g., to a plurality of instances 110 of the object 108 in the sensor data, e.g., to each instance 110 of the object 108 in the sensor data. The vehicle computer 102 or remote computer 104 can apply the same anonymization data to multiple instances 110 of the object 108 based on the identification of the multiple instances 110 of the object 108, described above. For example, the vehicle computer 102 or remote computer 104 can be programmed to apply the same anonymization data to the second instance 110b in the second image frame 116b or a second point cloud. For another example, the vehicle computer 102 or remote computer 104 can be programmed to apply the same anonymization data to the second instance 110b in sensor data from a different sensor 106 than detected the first instance 110a of the object 108. For another example, the vehicle computer 102 or remote computer 104 can be programmed to apply the same anonymization data to instances 110 of the object 108 before and after the object 108 is occluded from the sensor 106. Applying the same anonymization data can include blurring one of the instances 110 of the object 108, e.g., of the text or face. For example, blurring one of the instances 110 of the object 108 can mean blurring the subframe image 118 of the first instance 110a of the object 108 before applying the resulting blurred subframe image 120 to the second image frame 116b. For another example, blurring one of the instances 110 of the object 108 can mean blurring the subframe image 118 of the first instance 110a after applying the subframe image 118 to the second image frame 116b.

With reference to FIG. 3B, the anonymization data can be the blurred subframe image 120 from anonymizing the first instance 110a. The vehicle computer 102 or remote computer 104 can be programmed to blur the subframe image 118 of the first instance 110a in the first image frame 116a (as described above), and then apply the blurred subframe image 120 to the second instance 110b of the object 108 in the second image frame 116b. Applying the blurred subframe image 120 can include pasting the blurred subframe image 120 onto the second image frame 116b so that the second image frame 116b now includes the blurred subframe image 120 in place of the second instance 110b of the object 108. The blurred subframe image 120 can be scaled, warped, and/or stretched to fit over the second instance 110b of the object 108 in the second image frame 116b. The blurred subframe image 120 may also be shifted in color intensity to match the second image frame 116b.

With reference to FIG. 3C, the anonymization data can be the subframe image 118 of the first instance 110a of the object 108 from the first image frame 116a before blurring. The vehicle computer 102 or remote computer 104 can be programmed to apply the subframe image 118 to the second image frame 116b, and then blur the subframe image 118 in the second image frame 116b, as will now be described in turn.

The vehicle computer 102 or remote computer 104 can be programmed to apply the subframe image 118 to the second image frame 116b. Applying the subframe image 118 can include pasting the subframe image 118 onto the second image frame 116b so that the second image frame 116b now includes the subframe image 118 of the first instance 110a of the object 108 in place of the second instance 110b of the object 108. The subframe image 118 can be scaled, warped, and/or stretched to fit over the second instance 110b of the object 108 in the second image frame 116b. The subframe image 118 may also be shifted in color intensity to match the second image frame 116b.

The vehicle computer 102 or remote computer 104 can be programmed to blur the subframe image 118 in the second image frame 116b, i.e., to blur the location of the object 108 in the second image frame 116b after applying the subframe image 118 to that location. The result is a new, blurred subframe image 120 in the location of the second instance 110b of the object 108 in the second image frame 116b. Blurring the subframe image 118 can be based on contents of the subframe image 118 and of the second image frame 116b. For example, the vehicle computer 102 or remote computer 104 can use any suitable blurring techniques that transform the contents of the second image frame 116b after application of the subframe image 118, e.g., Gaussian blurring.

With reference to FIG. 3D, the anonymization data can be a randomized facial feature vector 122. For the purposes of this disclosure, a “facial feature vector” is defined as a collection of numerical values describing a geometry of a face. For example, the facial feature vector can be the numerical values used to characterize a face according to a facial-recognition technique, e.g., template matching; statistical techniques such as principal component analysis (PCA), discrete cosine transform, linear discriminant analysis, locality preserving projections, Gabor wavelet, independent component analysis, or kernel PCA; neural networks such as neural networks with Gabor filters, neural networks with Markov models, or fuzzy neural networks; etc. Using the randomized facial feature vector 122 can make the resulting image frames 116 more suitable for analysis, e.g., determining performance of the ADAS systems of the vehicle 100, reconstructing an impact involving the vehicle 100, etc., by preserving information about the face in an anonymized form.

The vehicle computer 102 or remote computer 104 can be programmed to load the randomized facial feature vector 122, determine a pose of the face in the second image frame 116b, generate a synthetic subframe image 126 of an anonymized face 124 from the randomized facial feature vector 122 in the pose of the face from the second image frame 116b, apply the synthetic subframe image 126 of the anonymized face 124 to the second image frame 116b, and blur the synthetic subframe image 126 in the second image frame 116b, as will now be described in turn.

The vehicle computer 102 or remote computer 104 can be programmed to load the randomized facial feature vector 122. The vehicle computer 102 or remote computer 104 can load the randomized facial feature vector 122 by generating the randomized facial feature vector 122, or the randomized facial feature vector 122 can be pregenerated and stored in memory. The randomized facial feature vector 122 can be generated by sampling the numerical values constituting a facial feature vector from respective distributions of the numerical values. The distributions can be derived from measurements of the numerical values from a population of faces.

The vehicle computer 102 or remote computer 104 can be programmed to determine the pose of the face in the second image frame 116b. The pose of the face is the orientation of the face, e.g., yaw, pitch, and roll, with respect to the sensor 106 that detected the second image frame 116b. The vehicle computer 102 or remote computer 104 can determine the pose according to any suitable technique for facial-pose estimation, e.g., convolutional neural networks, deep learning, etc.

The vehicle computer 102 or remote computer 104 can be programmed to generate the synthetic subframe image 126 of the anonymized face 124 from the randomized facial feature vector 122 in the pose of the face from the second image frame 116b. For example, if the randomized facial feature vector 122 provides relative positions of points on the anonymized face 124, the vehicle computer 102 or remote computer 104 can orient and scale the facial feature vector to match the pose of the face in the second image frame 116b, and generate polygons or other surfaces connecting the points on the anonymized face 124. The color(s) of the anonymized face 124 can be chosen according to the color(s) of the first instance 110a of the face or by sampling a distribution of colors. The resulting three-dimensional model can be projected to the field of view of the sensor 106 to form the synthetic subframe image 126.

The vehicle computer 102 or remote computer 104 can be programmed to apply the synthetic subframe image 126 to the second image frame 116b. Applying the synthetic subframe image 126 can include pasting the synthetic subframe image 126 onto the second image frame 116b so that the second image frame 116b now includes the synthetic subframe image 126 of the anonymized face 124 in place of the second instance 110b of the object 108. The synthetic subframe image 126 can be scaled, warped, and/or stretched to fit over the second instance 110b of the object 108 in the second image frame 116b. The synthetic subframe image 126 may also be shifted in color intensity to match the second image frame 116b.

The vehicle computer 102 or remote computer 104 can be programmed to blur the synthetic subframe image 126 in the second image frame 116b, i.e., to blur the location of the object 108 in the second image frame 116b after applying the synthetic subframe image 126 of the anonymized face 124 to the location. The result is a new, blurred synthetic subframe image 128 of the anonymized face 124 in the location of the second instance 110b of the object 108 in the second image frame 116b. Blurring the synthetic subframe image 126 can be based on contents of the synthetic subframe image 126 and of the second image frame 116b. For example, the vehicle computer 102 or remote computer 104 can use any suitable blurring techniques that transform the contents of the second image frame 116b after application of the synthetic subframe image 126, e.g., Gaussian blurring.

With reference to FIG. 3E, the anonymization data can be the adjusted three-dimensional positions of the points forming the first instance 110a in a first point cloud at the first time. The vehicle computer 102 or remote computer 104 can be programmed to determine the points forming the second instance 110b in a second point cloud 128 at the second time, determine motion of the object 108 from the first time to the second time, modify the adjusted positions of the points forming the first instance 110a by the determined motion, and move the positions of the points forming the second instance 110b to match the modified adjusted positions of the points forming the first instance 110a, or replace the points forming the second instance 110b in the second point cloud with points at the modified adjusted positions of the points forming the first instance 110a. The vehicle computer 102 or remote computer 104 can determine the points forming the second instance 110b by using, e.g., semantic segmentation. The vehicle computer 102 or remote computer 104 can determine the motion of the object 108 by comparing the locations of feature identified by the semantic segmentation in the first point cloud and the second point cloud 128. The determined motion can include, e.g., a bulk translation of a geometric center of the object 108 and a bulk rotation about the geometric center. During the bulk translation and bulk rotation, the relative positions of the points being transformed remain the same. The vehicle computer 102 or remote computer 104 can modify the adjusted positions by applying the bulk translation and bulk rotation to each of the adjusted positions. Finally, the vehicle computer 102 or remote computer 104 can make the points forming the second instance 110b match the modified adjusted positions of the points forming the first instance 110a, e.g., by replacing the points forming the second instance 110b with new points at the modified adjusted positions.

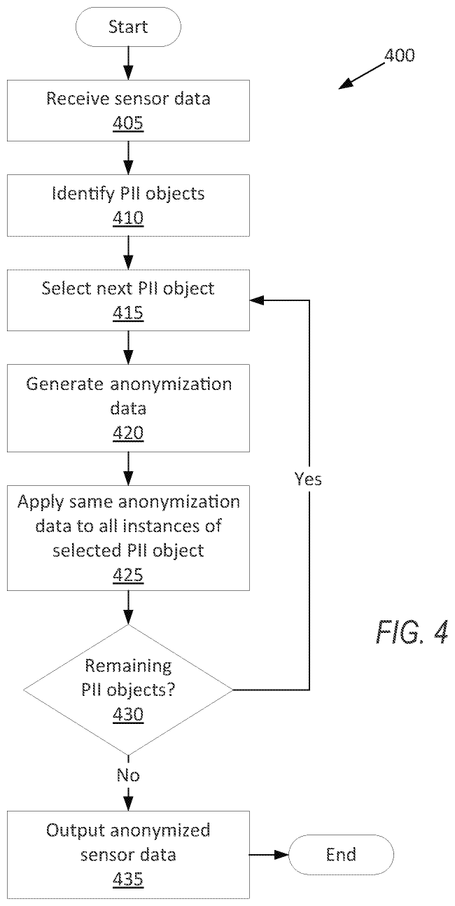

FIG. 4 is a process flow diagram illustrating an exemplary process 400 for anonymizing the sensor data. The memory of the vehicle computer 102 and/or remote computer 104 stores executable instructions for performing the steps of the process 400 and/or programming can be implemented in structures such as mentioned above. As a general overview of the process 400, the vehicle computer 102 or remote computer 104 receives the sensor data from the sensors 106 and identifies the objects 108 including PII. For each identified object 108, the vehicle computer 102 or remote computer 104 generates the anonymization data and applies the same anonymization data to each instance 110 of the respective identified object 108. Finally, the vehicle computer 102 or remote computer 104 outputs the resulting anonymized sensor data.

The process 400 begins in a block 405, in which the vehicle computer 102 or remote computer 104 receives the sensor data. For example, the vehicle computer 102 may collect the sensor data from the sensors 106 via the communications network 112 over an interval, e.g., a single trip or a preset interval. The preset interval may be based on the capacity of the vehicle computer 102. For another example, the remote computer 104 may receive the sensor data as a transmission from the vehicle computer 102 via the transceiver 114.

Next, in a block 410, the vehicle computer 102 or remote computer 104 identifies the objects 108 including PII, as described above.

Next, in a block 415, the vehicle computer 102 selects a next object 108 from the identified objects 108 from the block 410. For example, the objects 108 can be assigned an index value, and the vehicle computer 102 or remote computer 104 can start with the object 108 having the lowest index value and cycle through the objects 108 in ascending order of the index values.

Next, in a block 420, the vehicle computer 102 or remote computer 104 generates the anonymization data for the first instance 110a of the selected object 108 at the first time in the time series based on the sensor data of the first instance 110a, as described above. For example, the vehicle computer 102 or remote computer 104 can blur the first instance 110a in the first image frame 116a and collect the blurred subframe image 120 of the first instance 110a as the anonymization data, as described above with respect to FIG. 3B. For another example, the vehicle computer 102 or remote computer 104 can collect the unblurred subframe image 118 of the first instance 110a as the anonymization data and then blur the first instance 110a in the first image frame 116a, as described above with respect to FIG. 3C. For another example, the vehicle computer 102 or remote computer 104 can load the randomized facial feature vector 122, as described above with respect to FIG. 3D. For another example, the vehicle computer 102 or remote computer 104 can generate the adjusted positions of the points of a point cloud forming the first instances 110a, as described above with respect to FIG. 3E.

Next, in a block 425, the vehicle computer 102 or remote computer 104 applies the same anonymization data to each instance 110 of the object 108 in the sensor data, as described above. For example, for each instance 110 of the selected object 108, the vehicle computer 102 or remote computer 104 can apply the blurred subframe image 120 of the first instance 110a of the selected object 108 to the respective image frame 116, as described above with respect to FIG. 3B. For another example, for each instance 110 of the selected object 108, the vehicle computer 102 or remote computer 104 can apply the unblurred subframe image 118 of the first instance 110a of the selected object 108 to the respective image frame 116 and blur the subframe image 118 in that image frame 116, as described above with respect to FIG. 3C. For another example, for each instance 110 of the selected object 108, the vehicle computer 102 or remote computer 104 can generate a synthetic subframe image 126 of an anonymized face 124 from the randomized facial feature vector 122 in the pose of the face from the respective image frame 116, apply the synthetic subframe image 126 of the anonymized face 124 to the respective image frame 116, and blur the synthetic subframe image 126 in the respective image frame 116, as described above with respect to FIG. 3D. For another example, the vehicle computer 102 or remote computer 104 can apply the points in the adjusted relative positions of the first instance 110a to the points of the second instance 110b, as described above with respect to FIG. 3E.

Next, in a decision block 430, the vehicle computer 102 or remote computer 104 determines whether any identified objects 108 remain or whether the selected object 108 was the last identified object 108. For example, the vehicle computer 102 or remote computer 104 can determine whether the index value of the selected object 108 is the highest index value assigned. If any identified objects 108 remain, the process 400 returns to the block 415 to select the next identified object 108. If no identified objects 108 remain, the process 400 proceeds to a block 435.

In the block 435, the vehicle computer 102 or remote computer 104 outputs the anonymized sensor data. For example, the vehicle computer 102 can instruct the transceiver 114 to transmit the anonymized sensor data to the remote computer 104. After the block 435, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer comprising a processor and a memory, the memory storing instructions executable by the processor to:
receive sensor data in a time series from a sensor;
identify an object in the sensor data, the object including personally identifiable information;
generate anonymization data for a first instance of the object at a first time in the time series based on the sensor data of the first instance; and
apply the same anonymization data to a second instance of the object in the sensor data at a second time in the time series.

2. The computer of claim 1, wherein the sensor data in the time series includes a sequence of image frames, generating the anonymization data for the object occurs for a first image frame of the image frames, and applying the same anonymization data to the second instance of the object occurs for a second image frame of the image frames.

3. The computer of claim 2, wherein the object includes text, and applying the same anonymization data to the second instance of the object includes blurring the text.

4. The computer of claim 2, wherein the object includes a face of a person, and applying the same anonymization data to the second instance of the object includes blurring the face.

5. The computer of claim 4, wherein the anonymization data is a randomized facial feature vector.

6. The computer of claim 5, wherein the instructions further include instructions to determine a pose of the face in the second image frame, and applying the same anonymization data to the second instance of the object is based on the pose.

7. The computer of claim 6, wherein applying the same anonymization data to the second instance of the object includes to generate a subframe image of an anonymized face from the randomized facial feature vector in the pose of the face in the second image frame.

8. The computer of claim 7, wherein applying the same anonymization data to the second instance of the object includes to apply the subframe image of the anonymized face to the second image frame, and blur the subframe image.

9. The computer of claim 2, wherein the anonymization data is a subframe image of the first instance of the object from the first image frame.

10. The computer of claim 9, wherein applying the same anonymization data to the second instance of the object includes applying the subframe image to the second image frame and then blurring the subframe image in the second image frame.

11. The computer of claim 9, wherein the instructions further include instructions to blur the subframe image in the first image frame.

12. The computer of claim 2, wherein generating the anonymization data includes blurring a subframe image of the first instance of the object in the first image frame, and applying the same anonymization data to the second instance of the object includes applying the blurred subframe image to the second instance of the object in the second image frame.

13. The computer of claim 2, wherein applying the same anonymization data to the second instance of the object includes blurring a location of the object in the second image frame, and blurring the location of the object in the second image frame is based on contents of the second image frame.

14. The computer of claim 13, wherein the instructions further include instructions to blur the first instance of the object in the first image frame, and blurring the first instance in the first image frame is based on contents of the first image frame.

15. The computer of claim 1, wherein the object includes a face of a person.

16. The computer of claim 1, wherein the instructions further include instructions to apply the same anonymization data to each instance of the object in the sensor data.

17. The computer of claim 16, wherein applying the same anonymization data to each instance of the object includes applying the same anonymization data to instances of the object before the object is occluded from the sensor and to instances of the object after the object is occluded from the sensor.

18. The computer of claim 1, wherein the sensor is a first sensor, the sensor data is first sensor data, and the instructions further include instructions to receive second sensor data in the time series from a second sensor, and apply the same anonymization data to a third instance of the object in the second sensor data.

19. The computer of claim 18, wherein the first sensor and the second sensor are mounted to a same vehicle during the time series.

20. A method comprising:
receiving sensor data in a time series from a sensor;
identifying an object in the sensor data, the object including personally identifiable information;
generating anonymization data for a first instance of the object at a first time in the time series based on the sensor data of the first instance; and
applying the same anonymization data to a second instance of the object in the sensor data at a second time in the time series.
